(19) United States
(12) Patent Application Publication
(10) Pub. No.: US 2026/0233324 A1
(43) Pub. Date: Aug. 13, 2026

(54) Systems and Methods for Additive Deposition Patterns

(71) Applicant: Relativity Space, Inc., Long Beach, CA (US)

(72) Inventors: Vladislav Mogilevskiy, Long Beach, CA (US); Tyler Ledgett, Long Beach, CA (US); Alexander Weisfeld, Long Beach, CA (US)

(73) Assignee: Relativity Space, Inc., Long Beach, CA (US)

(21) Appl. No.: 19/402,577

(22) Filed: Nov. 26, 2025

Related U.S. Application Data
(60) Provisional application No. 63/757,266, filed on Feb. 11, 2025.
(60) Provisional application No. 63/774,640, filed on Mar. 19, 2025.

(51) Int. Cl. B23K 9/04; B33Y 10/00; B33Y 30/00; B33Y 50/02

(52) U.S. Cl. CPC B23K 9/042; B33Y 10/00; B33Y 30/00; B33Y 50/02

(57) ABSTRACT

Systems and methods for additive manufacturing techniques for deposition layering in additive manufacturing techniques. Various embodiments are directed to processes for additive manufacturing using deposition layer patterns. In some embodiments, deposition layer pattens provide printed components with desired geometries. Individual deposition layer pattern within a printed component can vary between layers, in accordance with several embodiments.

### CROSS-REFERENCES TO RELATED APPLICATIONS

The current application claims priority to Provisional Application No. 63/757,266, filed Feb. 11, 2025 and Provisional Application No. 63/774,640, filed Mar. 19, 2025, the disclosures of which are incorporated herein by reference in their entireties.

### FIELD OF THE INVENTION

This disclosure generally refers to systems and methods for additive manufacturing processes and structures formed thereby, and more particularly to deposition patterns for additive manufacturing processes.

### BACKGROUND

Additive manufacturing is a process by which a product or component is manufactured by adding one layer of material on top of another in a sequence or pattern that would result in a solid component being built. This method of manufacturing is commonly referred to as three dimensional or 3-D printing and can be done with different materials, including plastic and metal. There are many different processes available for implementing 3-D printing of articles, including, among others, direct energy deposition, powder bed fusion, cold spray, etc.

The raster patterns of an additive manufacturing process dictates the pattern in which the material is laid to form the solid component. The raster pattern geometry determines the shape and structure of the resulting component. Wire arc additive manufacturing is an additive manufacturing technique. In wire arc additive manufacturing, a material is melted by a welding arc and can be deposited in layers in a specific raster pattern.

### SUMMARY OF THE INVENTION

Systems and methods in accordance with some embodiments of the invention are directed to additive manufacturing deposition layer patterns.

In some embodiments, the techniques described herein relate to a method for depositing a layer pattern including: defining a perimeter pattern polygon, wherein the perimeter pattern polygon includes a first portion and a second portion; depositing the first portion of the perimeter pattern polygon, wherein depositing the first portion of the perimeter pattern polygon includes depositing a first tail portion outside the area defined by the perimeter pattern polygon, wherein the first tail portion extends from a start point on the first portion of the perimeter pattern polygon; depositing an in-fill pattern within an area defined by the perimeter pattern polygon, wherein depositing the in-fill pattern within the area defined by the perimeter pattern polygon ends near the start point; and depositing the second portion of the perimeter pattern polygon, wherein depositing the second portion of the perimeter pattern polygon includes depositing a second tail portion outside the area defined by the perimeter pattern polygon, wherein the second tail portion extends from an end point on the second portion of the perimeter pattern polygon.

In some embodiments, the techniques described herein relate to a method, further including depositing a second layer pattern on top of a first layer pattern, wherein depositing the first portion of the perimeter pattern polygon of the second layer pattern is different than a start point of the first layer pattern.

In some embodiments, the techniques described herein relate to a method, wherein depositing the first portion of the perimeter pattern polygon, depositing the in-fill pattern, and depositing the second portion of the perimeter pattern polygon includes depositing a material at a feed rate; wherein the feed rate is dynamically changed.

In some embodiments, the techniques described herein relate to a method, wherein the feed rate of depositing the in-fill pattern is greater than the feed rate of depositing the first portion and the second portion of the perimeter pattern polygon.

In some embodiments, the techniques described herein relate to a method, wherein the feed rate of depositing the in-fill pattern is less than the feed rate of depositing the first portion and the second portion of the perimeter pattern polygon.

In some embodiments, the techniques described herein relate to a method, wherein the perimeter pattern polygon includes a first corner and a second corner, wherein the step of deposition the first portion of the perimeter pattern polygon begins at the first corner.

In some embodiments, the techniques described herein relate to a method, further including depositing a second layer pattern including depositing the first portion of the perimeter polygon of the second layer pattern begins at the second corner.

In some embodiments, the techniques described herein relate to a method, wherein the in-fill lines are at an offset angle from the in-fill lines of the second layer pattern.

In some embodiments, the techniques described herein relate to a method, wherein the first corner and the second corner are adjacent corners within the perimeter pattern polygon, wherein the offset angle is equal to an interior angle of the perimeter pattern polygon.

In some embodiments, the techniques described herein relate to a system for weld path planning including: a controller including a processor and a memory, wherein the memory includes an application configured to direct the processor to perform a method for determining a layer pattern including: determining a perimeter pattern, including a first portion and a second portion; and determining an in-fill pattern within an area defined by the perimeter pattern; wherein the layer pattern is a portion of a weld path plan that runs continuously from the first portion into the in-fill pattern and from the in-fill pattern into the second portion.

In some embodiments, the techniques described herein relate to a system, wherein the first portion of the perimeter pattern further includes a first tail portion, wherein the first tail portion is outside the area defined by the perimeter pattern, wherein the second portion of the perimeter pattern further includes a second tail portion, wherein the second tail portion is outside the area defined by the perimeter pattern.

In some embodiments, the techniques described herein relate to a system, wherein the in-fill pattern includes a plurality of in-fill lines and a plurality of turn regions, and wherein the in-fill lines are approximately parallel.

In some embodiments, the techniques described herein relate to a system, wherein the first portion of the perimeter pattern includes a first side and a second side, wherein the second portion of the perimeter pattern includes a third side and a fourth side, and wherein the second side and the fourth side are approximately parallel to the in-fill lines.

In some embodiments, the techniques described herein relate to a system, wherein the in-fill lines are separated by an in-fill space, and wherein the turn region has a radius greater than the in-fill space.

In some embodiments, the techniques described herein relate to a system, wherein the in-fill pattern fills the area defined by the perimeter pattern.

In some embodiments, the techniques described herein relate to a system including: a controller including a processor and a memory, wherein the memory includes an application configured to direct the processor to perform a method, the method including: determining a plurality of layer patterns, wherein each layer pattern includes a continuous deposition, wherein each layer pattern includes: a perimeter pattern, including a first portion and a second portion; and an in-fill pattern within an area defined by the perimeter pattern, wherein the in-fill pattern includes a plurality of in-fill lines and a plurality of turn regions, and wherein the in-fill lines are approximately parallel; wherein the plurality of layer patterns are stacked, wherein a first layer pattern and a second layer pattern are adjacent in the stack, and wherein the in-fill lines of the first layer pattern are at an offset angle from the in-fill lines of the second layer pattern.

In some embodiments, the techniques described herein relate to a system, wherein each layer pattern includes a start point, wherein the start point is at a corner of the perimeter pattern.

In some embodiments, the techniques described herein relate to a system, wherein the start point of the first layer pattern is at a first corner of the perimeter pattern, wherein the start point of the second layer pattern is at a second corner of the perimeter pattern.

In some embodiments, the techniques described herein relate to a system, wherein the first corner and the second corner are adjacent corners within the perimeter pattern, wherein the offset angle is equal to an interior angle of the perimeter pattern.

In some embodiments, the techniques described herein relate to a system, wherein the first portion of the perimeter pattern of each layer pattern in the plurality of layer patterns includes a first side and a second side; wherein the second portion of the perimeter pattern includes a third side and a fourth side; and wherein the at least one of the first side, the second side, the third side, or the fourth side of the perimeter pattern of the first layer pattern is different than at least one of the first side, the second side, the third side, or the fourth side of the perimeter pattern of the second layer pattern.

Additional embodiments and features are set forth in component in the description that follows, and in component will become apparent to those skilled in the art upon examination of the specification or may be learned by the practice of the disclosure. A further understanding of the nature and advantages of the present disclosure may be realized by reference to the remaining portions of the specification and the drawings, which forms a component of this disclosure.

### BRIEF DESCRIPTION OF THE DRAWINGS

The description will be more fully understood with reference to the following figures, which are presented as embodiments of the invention and should not be construed as a complete recitation of the scope of the invention, wherein:

FIGS. 1A and 1B illustrate an example of a component formed with conventional wire arc additive manufacturing.

FIGS. 1C and 1D illustrate an example of a component formed in accordance with an embodiment.

FIG. 2 schematically illustrates a deposition pattern.

FIG. 3 illustrates a process for printing a layer pattern.

FIG. 4 schematically illustrates a deposition pattern with a sacrificial start tail and a sacrificial end tail.

FIGS. 5A and 5B schematically illustrate reorientation of the start point for deposition of layer patterns in successive layers.

FIGS. 6 and 7 schematically illustrate a deposition pattern with substantially uniform extended turn regions.

FIG. 8 schematically illustrates a deposition pattern with a last turn region extended beyond the previous turn regions.

FIGS. 9A and 9B illustrate a component printed in accordance with various embodiments.

FIGS. 10 and 11 schematically illustrates a deposition pattern with varied weld torch speed.

FIG. 12A schematically illustrates a side view of a weld path plan for a printed component with curved sides.

FIGS. 12B and 12C schematically illustrate layer patterns for a printed component with curved sides.

FIG. 13A schematically illustrates a side view of a weld path plan for a printed component in the shape of an arch.

FIGS. 13B and 13C schematically illustrate layer patterns for a printed component arch.

FIG. 14 illustrates a process for determining a plurality of layer patterns for a printed component.

FIG. 15 illustrates a plurality of layer patterns for a printed component.

### DETAILED DESCRIPTION OF THE INVENTION

It will be understood that the components of the embodiments, as generally described herein and illustrated in the appended figures, may be arranged and designed in a variety of different configurations. Thus, the following more detailed description of various embodiments, as represented in the figures, is not intended to limit the scope of the present disclosure but is merely representative of various embodiments. While various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages and similar language throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment. Thus, the phrases “in one embodiment,” “in an embodiment,” and similar language throughout this specification may but do not necessarily, all refer to the same embodiment.

Additive manufacturing (AM) is the process of creating an object by building on one or more deposited layers of a material. This process can be contrasted with conventional molding or casting techniques, in which components of an object are created via a premade mold or cast of the object and then assembled together.

Although it may have some benefits compared to conventional techniques, additive manufacturing creates challenges in ensuring that the final component has adequate engineering properties. Further, additive manufacturing is a genus term that actually references a number of different techniques, including, for example, binder jetting (BJT), cold spray additive manufacturing (CS), directed energy deposition (DED), wire arc additive manufacturing (WAAM) or directed energy deposition-arc (DED-arc), material extrusion, and powder bed fusion (PBF), and sheet lamination, including laminated object manufacturing (LOM) and ultrasonic additive manufacturing (UAM), among others. Each of these species of the additive manufacturing genus has different capabilities in terms of material limitations, overall component size attainable, individual feature size available, etc. ; each has unique challenges related to engineering properties.

Aspects of this disclosure provide for raster patterning techniques directed towards WAAM, however, it should be understood that raster patterning techniques disclosed herein are applicable to various AM techniques. WAAM specifically is a process in which a metal wire is provided from a tip of a welding torch while electrical energy is applied to the metal wire, melting it to allow it to be layered in the desired shape of the component being manufactured. More generally, material can be deposited in a deposition layer by a deposition head of the AM process. The deposition layer is the deposited material within a single layer of the AM component. The material is layered in the desired shape based on a specific layer pattern in which the welding torch is directed to move. A deposition layer is deposited according to a layer pattern. The layer pattern is the portion of the weld path plan provided for a deposition head in an AM process of a single layer within an AM component. The layer pattern may be designed by a computer program that directs the welding torch to begin depositing material, move, and stop depositing material as depicted in the layer pattern. Each layer is deposited in a layer pattern with successive layer patterns each layered upon the previous layer. Each layer pattern may consist of a perimeter pattern and an in-fill pattern. The perimeter pattern is the perimeter portion of the layer pattern based on the portion of the weld path plan provided for the perimeter of a single layer of the AM component. The perimeter pattern is generally the outermost region of the layer pattern. The perimeter pattern and/or the in-fill pattern may form areas of the exterior surface of the finished component. The in-fill pattern is the interior portion of the layer pattern within the perimeter pattern and based on the portion of the weld path plan provided for the interior of a single layer of the AM component. The in-fill pattern is the interior area of the pattern within the perimeter pattern. The in-fill pattern may deposit material within the entire area defined by the perimeter pattern, or it may partially deposit material within the area within the perimeter pattern based on the desired shape and structure of the finished component. As described herein, deposition layers can be understood as physical objects resulting from a deposition process, while layer patterns can be understood as constructs, such as portions of a weld path plan stored in a computer memory. However, for the sake of convenience, layer patterns may also be discussed as though they were themselves physical objects, i.e., layer pattern may occasionally be synonymous with deposition layer, as will be clear from the context.

In WAAM processes, material is deposited starting with the initial arc and deposition of the material. The start point of each deposition layer is when the heat is applied to the material to begin the deposition of the material. The start of a WAAM process for a layer pattern can result in component defects such as lumps or cavities. Lumps can be caused by excess material pooling during the initial heating of the material. Cavities can form through undeposited material, wherein the welding torch began moving according to the layer pattern before the material was sufficiently heated to be deposited. Similarly, in WAAM processes, the end point is when welding current is removed from the material to end the deposition of the material. As with the start point, the end point can also result in component defects due to the excess pooling and/or inadequate deposition of material when the weld arc is removed. In a WAAM process a deposition layer may consist of multiple start points and stop points, due to the deposition of a perimeter pattern and a separate deposition of an in-fill pattern. As described above, extraneous start points and stop points can result in defects in the finished component. Furthermore, pooling or cavities within each deposition layer can result in the finished component having an irregular or bumpy outer surface. The deposition layer defects can accumulate within the successive deposition layers resulting in a distorted finished component.

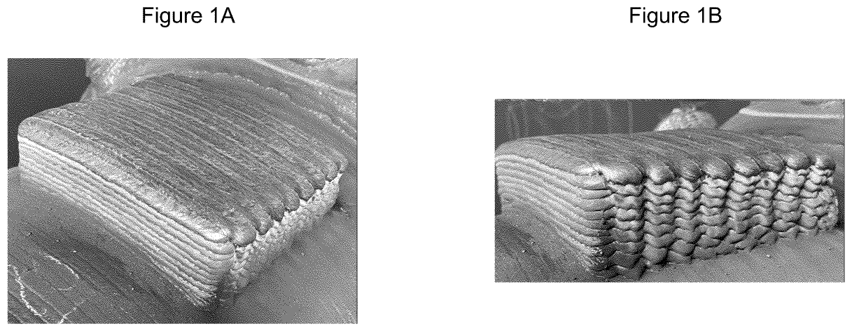

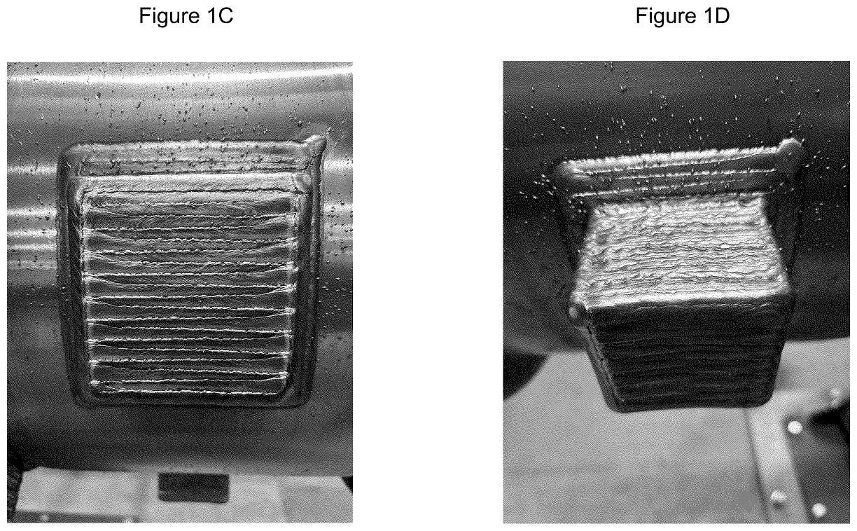

Aspects of this disclosure minimize component defects and are directed to techniques to manufacture finished components with a near-net shape, having a substantially level outer surface and/or generally sharp corners. Various embodiments described herein can be utilized to manufacture feature components integrated on cladded regions, meaning regions with WAAM layers formed on a non-WAAM manufactured substrate, or a WAAM manufactured substrate made of a different metal than the cladded material, or a WAAM manufactured substrate made at an earlier time. Various embodiments described herein can also be utilized to manufacture feature components integrated on a non-WAAM or WAAM manufactured substrate directly. In some embodiments the components may have one, some, or all of the following advantages. The substantially level feature structures and/or sharp corners of many embodiments produce very near-net shape components due to the reduced waste from defects compared to structures manufactured without the techniques described herein. Components manufactured in accordance with several embodiments result in decreased defects and resulting component distortions compared to components manufactured without the techniques described herein. The reduction in defects comparatively reduces the waste included in the finished component. In some embodiments, the substantially level outer surface has comparatively reduced deviation from the designed component, such as a substantially planar surface or a substantially curved surface wherein the length and/or width of the patterns is modulated over the course of the build. In many embodiments, the substantially level outer surface is an external surface lacking-large scale irregularities. WAAM clad dual-curvature base surfaces are non-flat, however, can be substantially level when quantified by the variable roughness and dual curvature. The variable roughness is the input specifications from the component's modeled geometry measured against the surface of the printed feature. Variable roughness may be quantified by the measured difference between the printed component and the modeled component at designated call out dimensions. The difference measured is the overprint. In various embodiments a component is level when the overprint is approximately 0.25 inches at the callout dimensions. In many embodiments a component is level when the overprint is approximately 0.225 inches. In several embodiments a component is level when the overprint is approximately 1 millimeter. The dual curvature measures the deposition pattern curvature against the desired curvature of the component. In many embodiments, the component has a level outer surface with dual curvature of approximately 0.1°. In several embodiments, the component has a level outer surface with a dual curvature of less than 0.1°. A component printed with conventional WAAM techniques may have significant dual curvature and variable roughness, as shown in FIGS. 1A and 1B respectively. In contrast, a component printed in accordance with the disclosure herein has reduced dual curvature and variable roughness, as shown in FIGS. 1C and 1D respectively.

In many embodiments, the perimeter pattern resembles a polygon. Aspects of this disclosure are directed towards a rectangular or square perimeter pattern. However, it should be understood that any perimeter pattern resembling a polygon is disclosed herein, including but not limited to a triangle, a pentagon, a hexagon, an octagon, and any other polygon. In many embodiments the sides of each perimeter pattern polygon are equal. A corner is formed where two sides of the perimeter pattern polygon meet and defines an interior angle. In some embodiments, the interior angle of every corner of the perimeter pattern polygon is equal.

In some embodiments, within a single layer pattern, one or more perimeter pattern sides will be deposited initially, followed by an in-fill pattern, followed by one or more remaining perimeter pattern sides. In several embodiments, approximately half of the number of sides of the perimeter pattern polygon are initially deposited. After half of the initial perimeter pattern polygon sides are deposited, the in-fill pattern can be deposited. For example, the in-fill pattern can be a raster pattern, where the raster pattern is a scanning motion, wherein an in-fill pattern line is deposited in a line in a first linear direction, turns, and another in-fill pattern line is deposited in the opposite linear direction. In many embodiments, the turn is at or near the perimeter pattern. Though a raster pattern is described, any pattern shape can be utilized to form the in-fill pattern. After the in-fill pattern is fully deposited, the remaining perimeter pattern polygon sides are deposited.

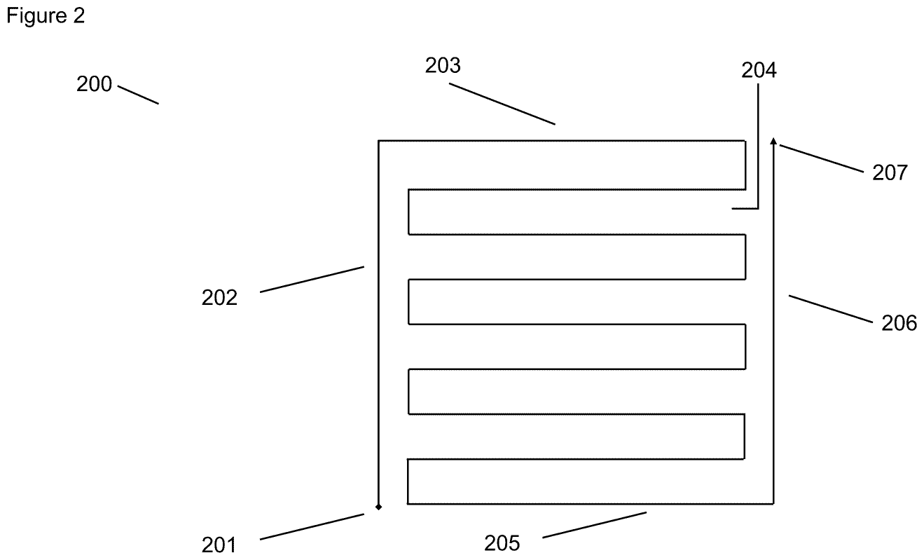

In some embodiments one or more adjacent perimeter pattern sides are deposited initially, then the in-fill pattern, and then the remaining adjacent perimeter pattern sides are deposited. In some embodiments, the perimeter pattern is a square shape with four 90° corners. In several embodiments, the perimeter of the component is a polygon with equal interior corner angles. In many embodiments, each layer pattern begins and ends at a corner of the component polygon. In several embodiments, the start and end of the layer pattern are at opposite corners. FIG. 2 depicts a rectangular layer pattern in accordance with an embodiment. The layer pattern 200 starts at a corner 201 of the perimeter pattern and prints a first 202 perimeter pattern side and an adjacent second 203 perimeter pattern side. The layer pattern 200 then continues printing the in-fill pattern in a raster pattern 204, finishing the in-fill raster pattern 204 at or near the start point 201. In a continuous print, the layer pattern 200 then prints a third 205 perimeter pattern side and an adjacent fourth 206 perimeter pattern side. The layer pattern 200 ends the continuous print at an end corner 207 opposite the start corner 201. The resulting layer pattern 200 has a perimeter pattern start at the corner 201 formed by adjacent first 202 and third 205 perimeter pattern sides and ends at the corner 207 formed by adjacent second 203 and fourth 206 perimeter pattern sides. This perimeter pattern, in-fill pattern, perimeter pattern sequence allows continuous deposition of a single layer within the weld path plan. In many embodiments, the perimeter pattern and the in-fill pattern are deposited with a single start point and a single end point. As such, the number of defects is comparatively reduced to those inherent in WAAM processes. The comparatively reduced number of defects within each deposition layer improves the resulting in a substantially level exterior surface of the finished component.

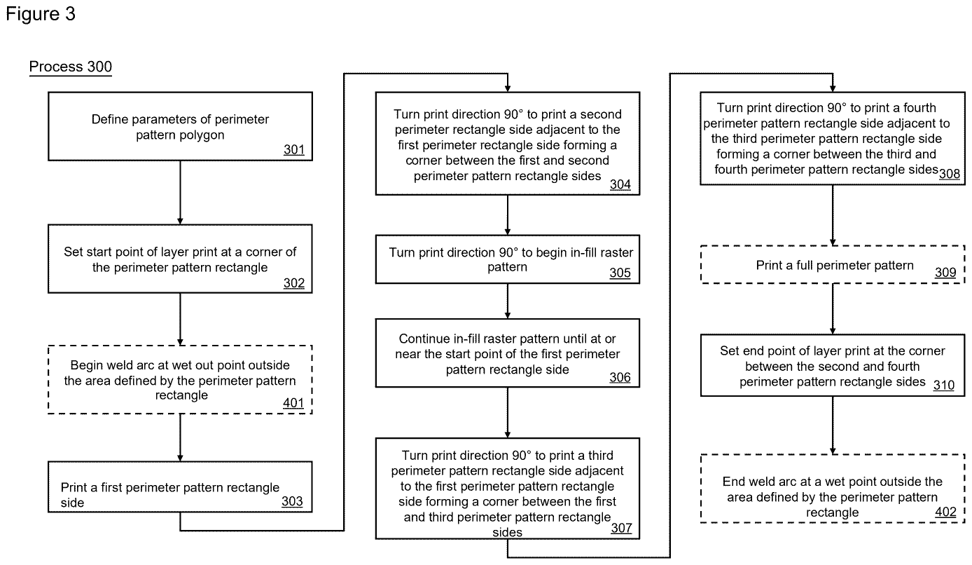

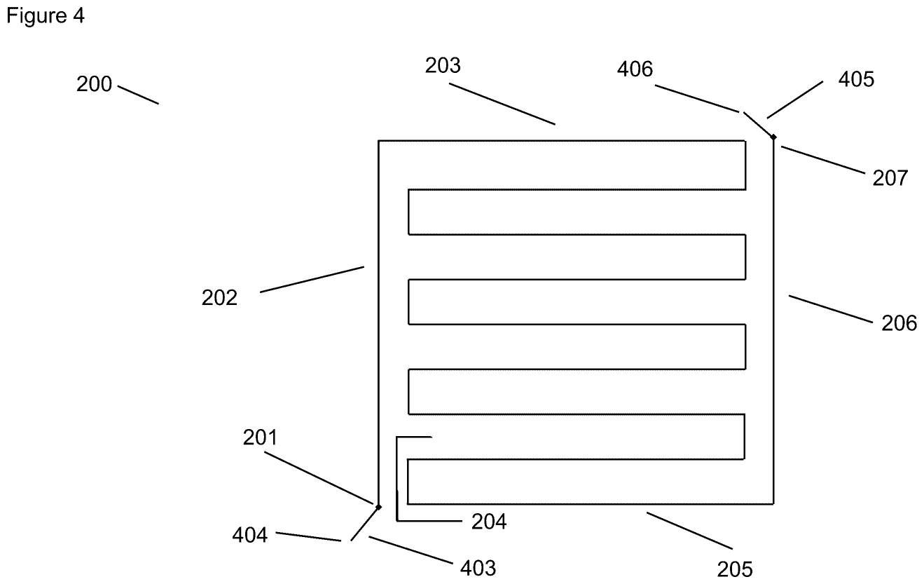

FIG. 3 depicts Process 300, a printing process of a WAAM layer pattern of a rectangular perimeter pattern polygon in accordance with an embodiment. The parameters and geometry of a desired component are (301) defined in a computer program capable of programming the movement of a WAAM weld torch. A start point is (302) determined at a corner of the perimeter polygon where material deposition begins according to the layer pattern. Optional step 401 is discussed in the context of FIG. 4 below. In some embodiments, the perimeter pattern polygon is a rectangle. A first perimeter pattern rectangle side is (303) printed. A second corner is formed by (304) turning the print direction 90° to begin printing a second perimeter pattern rectangle side. Turning the print direction 90° (305) to begin the in-fill pattern at or near the designed third corner. The in-fill pattern deposits material in a scanning pattern within the defined perimeter pattern, turning approximately 180° each time. The in-fill pattern may be designed to completely fill the area defined by (306) the perimeter pattern with the last in-fill line ending at or near the start corner. Without halting the material deposition, the print direction is (307) turned 180° to print a third perimeter pattern rectangle side. This third perimeter pattern rectangle side is adjacent to the first perimeter pattern side and forms a third corner of the perimeter pattern at or near the start point. The print direction then (308) turns 90° to print a fourth perimeter pattern rectangle side. The fourth perimeter pattern rectangle side is adjacent to the second perimeter pattern rectangle side and forms a fourth corner opposite the start corner. In a continued deposition, the layer pattern may optionally comprise a (309) full perimeter pattern deposition, starting and ending at the fourth corner to compensate for decreased material deposition at the edges of layer pattern. There may be decreased material deposition at the edges because the raster pattern is designed to have each weld bead either cover or be covered by half of an adjacent weld bead. Since the outer half of the perimeter pattern weld beads cannot be covered by the adjacent in-fill pattern weld beads, the outer edge of the perimeter pattern may lack material deposition over the course of multiple deposition layers. In some embodiments, the lack of material deposition is compensated for by depositing a full extra set of perimeter edges through the additional perimeter pattern deposition. In some embodiments, the optional additional perimeter pattern deposition may be included on a pre-determined interval. For example, an additional perimeter pattern deposition may be included on every third layer pattern depositions. The layer pattern is programmed to (310) end the layer pattern at or near the end corner opposite the start corner. Optional step 402 is discussed in the context of FIG. 4 below.

In several embodiments, the start point of each deposition layer is at or near the corner of the perimeter pattern. Each deposition layer begins at or near a perimeter pattern to localize defect risks at or proximate to the perimeter. The localized defects facilitate detection by non-destructive evaluation and improve the likelihood that the defects can be cleaned or removed in later processing of AM components compared to defects that are deeper within the printed component or structure.

In many embodiments, the layer pattern begins beyond the area of the desired component. The distance from the area of the defined component to the programed start point is the tail in distance. The tail in distance creates a sacrificial tail that can be removed after the print is completed through machining, sanding, or another processing application. In some embodiments, the tail in distance is determined by the size of the melt spread of the material when it is initially heated at the start point. In many embodiments, the wet out point is the melt spread of the material, radially from the center of the wire, when the initial arc is applied to material. In some embodiments, the tail in distance will utilize additional material than necessary to print the deposition layer. The length of additional material may be less than the distance to the tail in distance. This difference prevents buildup or pooling of additional material when the wire is initially heated.

As discussed above, certain embodiments include the inventive realization that defects and distortions in the finished component can be caused by end points within the deposition layer. Aspects of this disclosure are directed towards techniques to improve a finished component with a substantially level exterior surface by minimizing defects caused by the end point of material deposition within a layer pattern. In various embodiments the layer pattern ends beyond the area of the desired component. In many embodiments, the end point is at or near the corner of the perimeter pattern. As discussed above, the localized end point allows for sharper corners because sides of the perimeter pattern comprise a continuous weld line. In various embodiments, the last perimeter pattern polygon side deposited ends past the corner of the perimeter pattern polygon such that a sacrificial tail is formed outside the defined area of the finished component. In various embodiments, the end point sacrificial tail may be removed in post-print processing techniques. The layer pattern can be designed to continue applying the weld arc to the material after the perimeter pattern side connects with the adjacent perimeter pattern sides. In many embodiments, the end point sacrificial tail prevents pooling and/or valleys within the layer pattern. The resulting end point sacrificial tail comprises the reduced material output as the heat source is removed from the material. By pulling the reducing material output away from the layer pattern, the effect of excess pooling of material as the heat source is removed is reduced. In many embodiments, the end point sacrificial tail allows for the WAAM process to ramp down and pull excess material away from the layer pattern. This prevents the accumulation of excess material across multiple deposition layers as the component is printed.

FIG. 4 depicts a rectangular layer pattern in accordance with an embodiment having a sacrificial start tail 403 and a sacrificial end tail 405. It should be understood, in accordance with various embodiments, that a layer pattern may have one or more sacrificial tails. The sacrificial start tail 403 extends from the start corner 201 and is at an angle to the first perimeter pattern side 202. The layer pattern comprises a starting tail in distance 404, a distance from the start corner 201 where heat is applied to the feed material to begin material deposition, according to the weld path plan, outside the area defined by the perimeter pattern. The sacrificial end tail 405 extends from the end corner 207 at an angle to the fourth perimeter pattern side 206. The layer pattern comprises an ending wet out point at a stopping tail out distance 406, a distance from the end corner 207 where heat is removed from the feed material to stop material deposition, according to the weld path plan, outside the area defined by the perimeter pattern. One or more sacrificial tails may be included in a layer pattern as described in FIG. 3 with optional steps included. The layer pattern 200 may be programmed to 401 begin depositing material at the tail in distance 404 outside the area defined by the perimeter pattern, such that a sacrificial tail is formed from the tail in distance 404 to the start corner 201 prior to the first perimeter pattern side 202. The layer pattern 200 may further be programmed to 402 remove the weld arc from the weld material at a tail out distance 406 outside the area defined by the perimeter pattern, such that a sacrificial end tail 405 extends from the end point to the tail out distance 406.

Aspects of this disclosure are directed towards techniques to produce components with a substantially level outer surface, with reduced variable roughness, through rotating the orientation of successive layer patterns. As described above, aspects of this disclosure are directed towards components manufactured through WAAM processes. In WAAM processes, a component is formed through successive layering of patterned deposition of a material. Distortions in a finished component can result from excess pooling and/or caving in individual deposition layers that are successively stacked. In WAAM processes, a defect can accumulate as the layer pattern is printed in successive layers resulting in distortions in the finished component in the area of the stacked defect.

In various embodiments, a subsequent layer pattern is orientated to begin at a different location than the previous layer pattern. In AM processes, each layer pattern within the weld path plan for deposition has a start point and an end point. The start point of the layer pattern is where the material deposition begins. The end point of the layer pattern is where the material deposition finishes. In many embodiments, each layer pattern begins and ends at a corner of the perimeter pattern. A first layer pattern can begin at or near a first corner of the perimeter pattern and end at or near a corner opposite the first corner of the perimeter pattern. The next layer pattern can begin at or near a second corner of the perimeter pattern and end at a corner opposite the second corner. The reorientation of the start point can be through the rotation of the component on a fixture or platform wherein the platform is rotated by approximately an angle supplementary to the interior angle of the perimeter pattern polygon. In various embodiments, the torch head or weld point of the AM process may be rotated while the component being printed remains fixed. The weld torch may be rotated to begin the next deposition layer by approximately an angle supplementary to the interior angle of the perimeter pattern polygon. The weld torch may be configured to deposit layer patterns according to a computer program. In some embodiments, the weld torch may be programmed to begin deposition layer at a different start point than the previous deposition layer. The component may remain fixed while the weld torch is configured to be repositioned and begin a subsequent deposition layer in a different location than the previous deposition layer start point. In some embodiments, the weld point and the component may be configured to move the orientation of the weld according to a pre-determined computer program to rotate the start point of subsequent deposition layers. Aspects of this disclosure are directed towards a square perimeter pattern polygon comprising four interior angles of 90°. In an example embodiment, a first layer pattern is deposited at a first corner and ends at a corner opposite the first corner. The weld head reorientates 90° to begin depositing the next layer pattern at a second corner and end at a corner opposite the second corner. Several embodiments are directed towards triangle, hexagon, and octagon perimeter pattern polygons with reorientation rotations between each layer approximately 120°, 30°, and 22.5° respectively. In some embodiments, the subsequent layer pattern begins depositing material at the next corner in a clockwise direction from the previous layer pattern start point. In some embodiments, the subsequent layer pattern begins depositing material at the next corner in a counterclockwise direction from the previous layer pattern start point. In several embodiments, the direction of rotation switches for each subsequent layer pattern, wherein the layer pattern is repeated but with an inverse printing direction. For example, with a rectangular perimeter pattern, the perimeter pattern sides are printed in a clockwise direction from the start point. After the start point has returned to the initial start point, the next perimeter pattern sides will be printed in a counterclockwise direction from the start point. By changing the start and end point of each layer pattern, variations in material deposition can be distributed evenly, negating uneven accumulation of material resulting in a substantially level exterior finished component. The layer patterns may accumulate slightly more material in some sections than others, irrespective of potential defects. The purpose of rotating the orientation and position of the start point is to prevent depositing excess material in the same spit in every deposition layer, but rather spread it out evenly and preventing uneven build up.

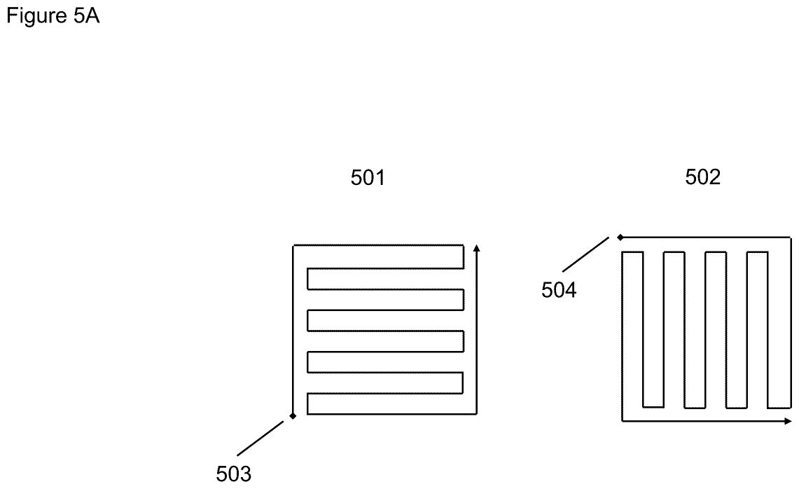

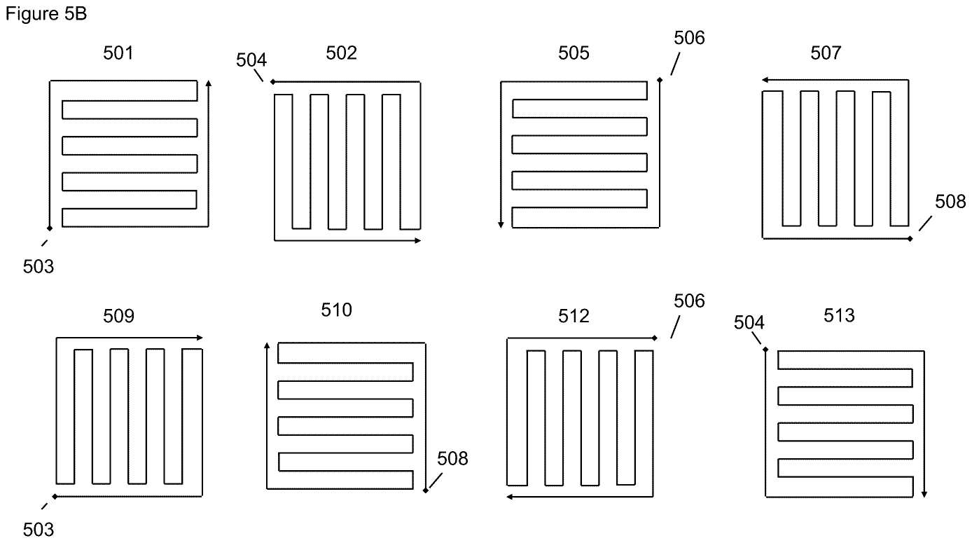

FIGS. 5A and 5B depict a series of layer patterns within a weld path plan wherein the start point of subsequent layer patterns is rotated. It should be understood that the rotation of the start point between layer patterns may be due to the repositioning of the component, the repositioning of the weld torch, the repositioning of the programed weld point, or in any other manner consistent with this disclosure. FIG. 5A depicts a first layer pattern 501 and a second layer pattern 502 wherein the start point of the second layer pattern 504 is deposited on a different corner than the start point of the first layer pattern 503. FIG. 5B depicts the inverse printing process, wherein the layer pattern is printed and rotated in a clockwise direction 501, 502, 505, 507 and then printed and rotated in a counterclockwise direction 509, 510, 512, 513. It should be understood that the inverse printing may also continue to be rotated in the same direction, even if the print direction is different.

Aspects of this invention are directed towards in-fill patterns comprising a raster pattern and/or a scanning pattern, wherein the in-fill pattern consists of a back and forth deposition pattern to incrementally fill the area defined by the perimeter pattern. In several embodiments, the in-fill pattern is deposited in the entire area defined by the perimeter pattern. In some embodiments, the in-fill pattern is deposited in a zig zag pattern, wherein the material is deposited in a back-and-forth motion. In various embodiments, the in-fill pattern comprises a series of lines that may be approximately parallel. The in-fill pattern is deposited in a scanning motion within the perimeter pattern in continuous lines, depositing a first line, turning at or near the perimeter pattern, and depositing a second line approximately parallel to the first line. The in-fill pattern may comprise sufficient repeated lines to substantially fill the entire area defined by the perimeter pattern, deposited in opposite linear directions. In some embodiments, the turn region can form a rounded arc, wherein the in-fill pattern has designated turn radius less than a 180° in-fill pattern turn around. In some embodiments, the turn region can comprise a square motion, wherein the turn region reaches the end of a line the in-fill pattern turns in two successive approximately perpendicular directions and continues depositing a line in the opposite direction as the previous line.

Various deposition techniques may be utilized for the deposition of the perimeter and in-fill patterns. WAAM techniques described herein comprise stringer deposition and weave deposition. However, any suitable deposition technique may be utilized. In stringer deposition, a weld line is deposited in a substantially linear single deposition. In weave deposition, a weld line is deposited through a substantially zig-zag pattern, wherein the weld line is thicker based on the amplitude of the zig-zag motion.

In stringer deposition techniques, a square turn region can result in lack of fusion through inadequate weld line overlap. This can result in structural defects in the finished component. The layer patterns with insufficient in-fill patterning at or near the perimeter pattern result in decreased fusion between deposition layers. Additionally, the presence of cavities is common at or near the perimeter pattern sides due to inadequate weld bead layering as described above.

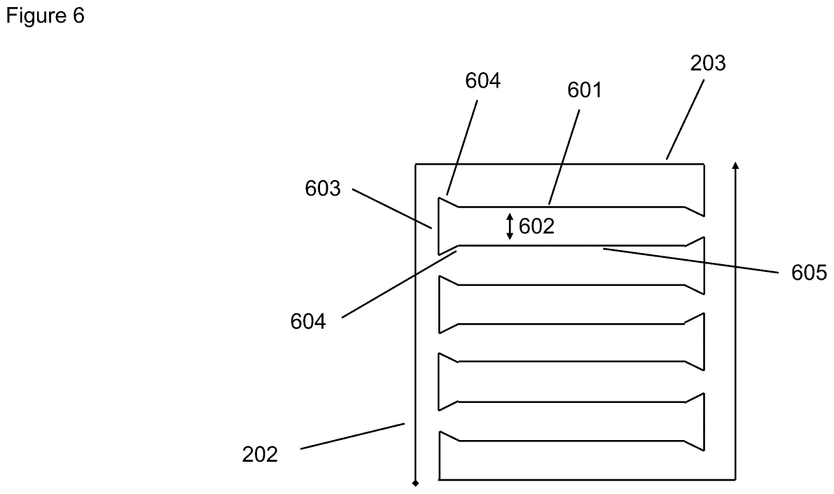

Aspects of this disclosure are directed towards the turn region of the in-fill pattern having an extended turn region, wherein instead of a series of perpendicular turns at or near the perimeter pattern, the turn region extends towards the previous line before making the turn. When the in-fill pattern line approaches the perimeter pattern, the in-fill pattern line extends at an angle towards the previous in-fill pattern line and away from the next in-fill pattern line. The extended in-fill pattern line turns towards the next in-fill pattern line past the deposited in-fill pattern line and beyond the line of the next in-fill pattern line, such that when the extended in-fill pattern line turns towards depositing the next in-fill pattern line, approaching at an angle. In various embodiments, the extended turn region may resemble a trapezoid as depicted in FIG. 6. The extended turn region 603 is wider than the space between the in-fill pattern lines 602. The first in-fill pattern line 601 extends parallel to a perimeter pattern side 203. When the first in-fill pattern line approaches an adjacent perimeter pattern side 202, the layer pattern is programmed to extend the in-fill pattern line of the turn region 604 towards the previous pattern line 203. After extending the in-fill pattern line the layer pattern is programmed to turn the print direction to create an extended turn region 603. The extended turn region 603 extends beyond the second in-fill pattern line 605. The layer pattern is programmed to turn the print direction to extend the in-fill pattern line 604 to connect the second in-fill pattern line 605.

In prior weave depositions during a WAAM process, the in-fill pattern may not turn at or near the perimeter pattern. Such weave deposition of the in-fill pattern lines may arbitrarily turn early resulting in significant deformations in the finished component due to irregular valleys and bumps in individual layer patterns. In contrast, in various embodiments, during weave deposition of the in-fill pattern, the layer pattern is programed to switch from weave deposition to stringer deposition at a defined spot as the in-fill pattern line approaches the perimeter pattern. The programmed switch between deposition techniques forces the weld torch to deposit material within the entire area defined by the perimeter pattern. When the in-fill pattern switches to stringer deposition, the stringer deposition may be programmed as an extended turn region. As described above, the extended turn region extends the in-fill pattern line towards the previous in-fill pattern line before turning at or near the perimeter pattern. This extended turn region angle extension length may have approximately the same length as the amplitude of the weave deposition. The extended turn region extends beyond the next in-fill pattern line and turns again to deposit material in the next direction creating a second angled turn region extension. The turn region extends beyond the next in-fill pattern line such that the return angled extension is approximately equal to the weave amplitude. Upon return to the linear region of the next in-fill pattern line the deposition may return to weave deposition techniques.

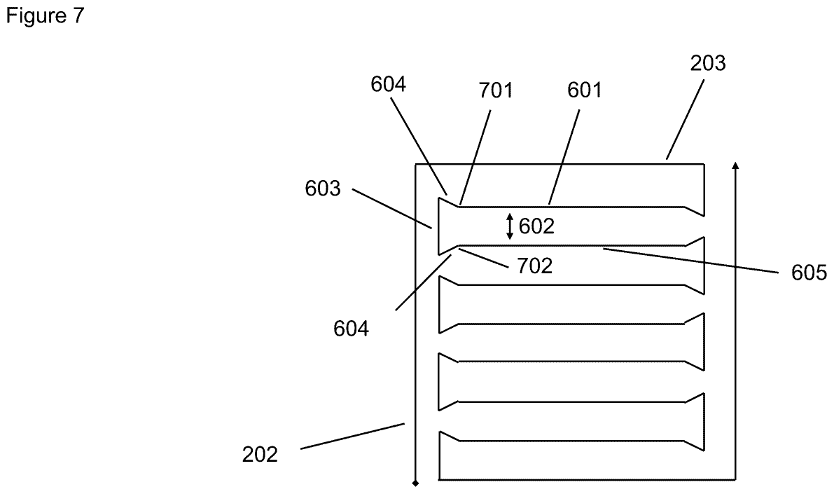

FIG. 7 depicts an extended turn region in accordance with an embodiment. The extended turn region 603 is wider than the space between the in-fill pattern lines 602. The first in-fill pattern line 601 extends parallel to a perimeter pattern side 203. When the first in-fill pattern line approaches an adjacent perimeter pattern side 202, the layer pattern switches from weave deposition to stringer deposition at a designated point 701. At the designated point 701, the layer pattern is programmed to extend the in-fill pattern line of the turn region 604 towards the previous pattern line 203 utilizing stringer deposition techniques. After extending the in-fill pattern line the layer pattern is programmed to turn the print direction to create an extended turn region 603. The extended turn region 603 extends beyond the second in-fill pattern line 605. The layer pattern is programmed to turn the print direction to extend the in-fill pattern line 604 to connect the second in-fill pattern line 605. The layer pattern is designed to switch from stringer deposition to weave deposition at a designated point 702 after the extended in-fill pattern line 604 connects to the second in-fill pattern line 605.

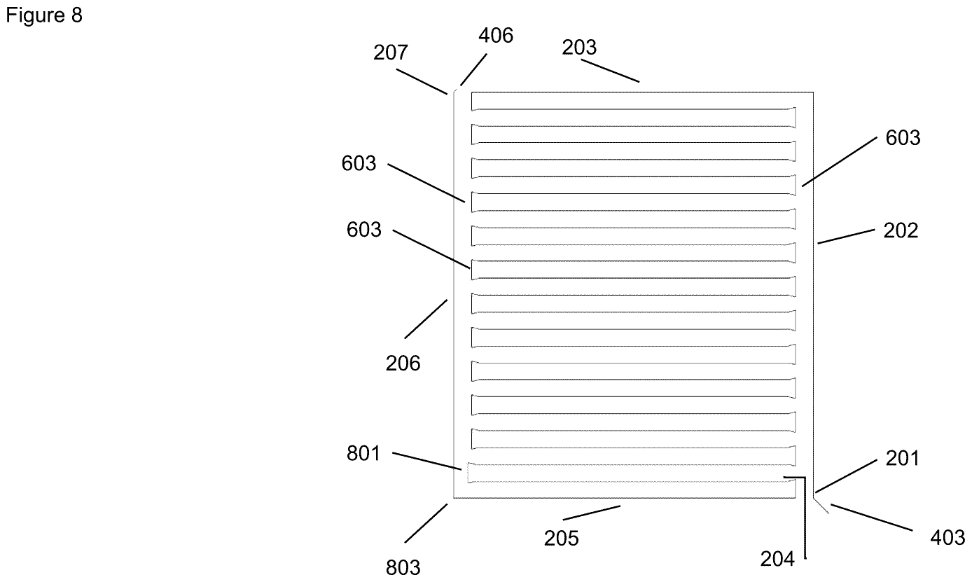

In WAAM processes, the deposition layers adhere through the fusion of molten material from the input and the previously deposited layer. As described above, the layer pattern deposition may be a single continuous deposition beginning and ending with adjacent perimeter patterns. In various embodiments, the last adjacent corner deposited in the perimeter pattern may be the last corner patterned during the in-fill patterning. In many embodiments last in-fill pattern is deposited near a perimeter pattern corner. As a result of the continuous deposition the component has been heated significantly during the layer patterning and may result in uniform material deposition profiles within the layer patterns and a consequent decrease in material accumulation in the build direction as heat accumulates. Some embodiments are directed towards the last turn region in the in-fill pattern being extended in comparison to the previous turn regions. The comparatively larger turn region deposits additional material near the heated perimeter corner. The deposition of the additional material allows for additional buildup where material would otherwise have insufficient buildup relative to the rest of the layer such that the decreased material deposition is counteracted. As a result, as the deposition layers are continuously layered, the decreased deposition in the build direction does not propagate because the extended last turn region in the same layer pattern fills the later printed corner where heat would otherwise lead to decreased vertical material build. In some embodiments, the in-fill pattern turn region may be extended to be larger than the previous turn regions, such that the last extended turn region extends closer to the perimeter pattern comparatively to the other turn regions. In some embodiments, the last in-fill turn region may be the only extended turn region. In many embodiments, all the in-fill turn regions are extended and the last in-fill turn region is comparatively larger. FIG. 8 depicts a layer pattern in accordance with various embodiments of continuous layer pattern deposition wherein the last turn region is larger than the previous turn regions. The last in-fill turn region 801 is larger than the previous in-fill extended turn regions 603. The last in-fill turn region 801 is near the corner 803 formed by the last two adjacent perimeter pattern sides deposited 205, 206. This is as compared to FIG. 7 where all the in-fill extended turn regions are substantially uniform in size.

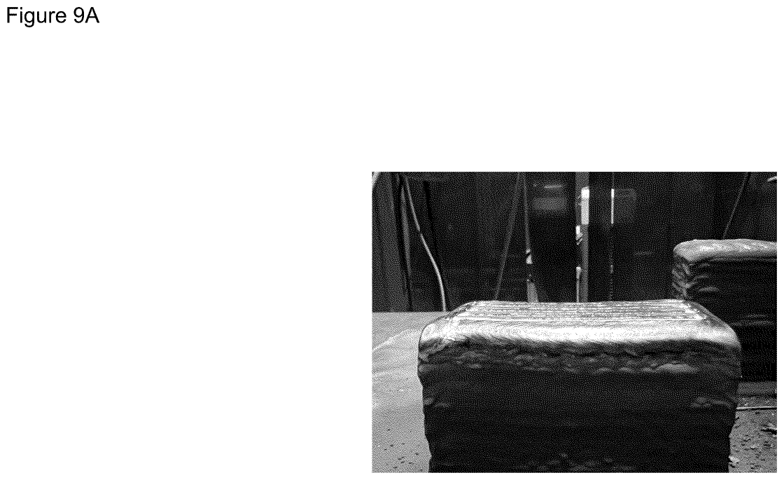

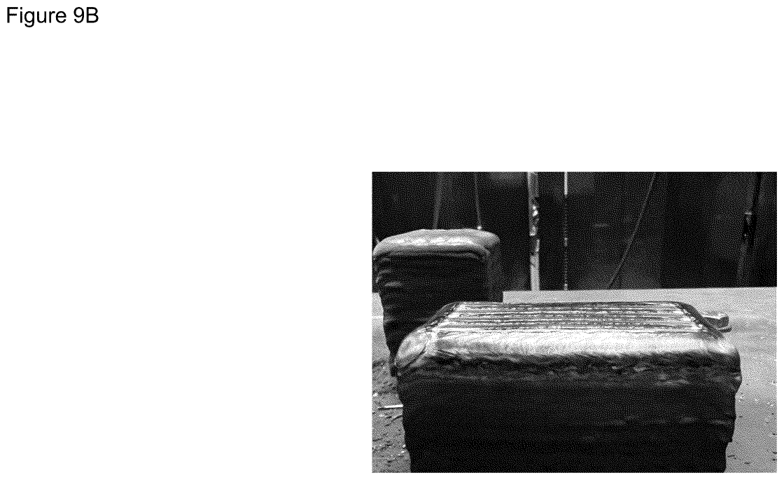

In WAAM processes, the finished component may have a different final geometry than that of the modeled component. The finished component may have a different height than the modeled component. The finished component may have distortions such as concavities and convexities. The layer patterns of various embodiments may incorporate logic into the layer patterns. The logic incorporated may adjust various parameters of the layer pattern deposition process. In AM, various parameters within the deposition process are described herein, including but not limited to the speed of the movement of the weld arm through the layer pattern, the direction of movement of the weld arm through the layer pattern, and the temperature of the printed component and/or the feed stock material. In particular, if the feed rate of the feed stock remains constant, the speed of the movement of the weld torch can affect the resulting geometry of the layer pattern. The slower the weld torch moves through the layer pattern; the more material may be deposited as compared to the weld torch moving at a faster speed through the layer pattern. The longer the weld torch takes to move through a section of the layer pattern, the more material may be deposited. A slower weld torch speed can result in a thicker deposition due to the increased material deposited. The logic incorporated may adjust the speed of the movement of the weld torch to adjust the amount of material deposited. The increased speed of the weld torch decreases the amount of material deposited. The decreased speed of the weld torch increases the amount of material deposited. FIG. 9A provides an example of a component printed without logic for speed adjustment incorporated in the layer patterns. FIG. 9B provides an example of a component printed with logic for speed adjustments incorporated in the layer patterns, resulting in a finished component with a flatter geometry.

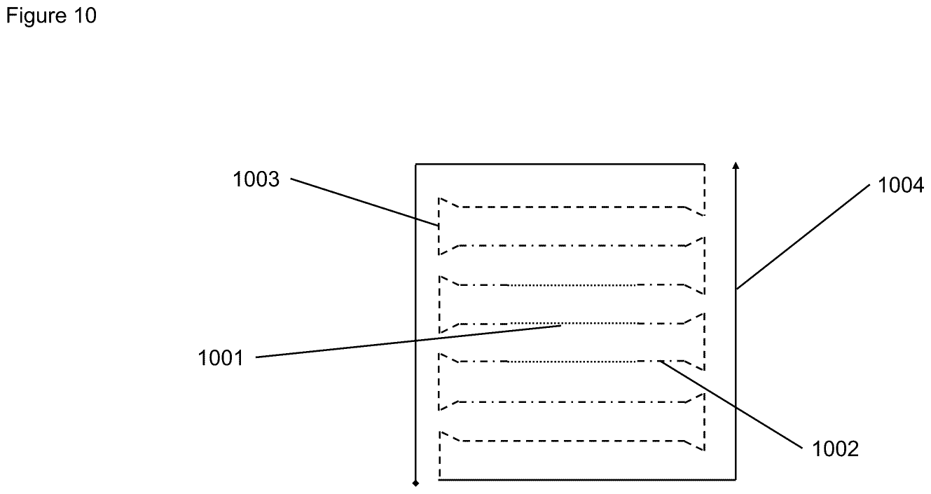

A printed component may be evaluated after printing to determine areas of concavity and convexity in the finished component. In subsequent prints of the same or similar component, the layer patterns may be adjusted by adjusting the speed of the weld torch along the layer pattern to account for these defects. Adjusting the speed of the weld torch allows for increased control over the height of deposition layers. As the speed of the weld torch speed is decreased and the feed rate remains consistent, the material deposited will pool more such that the deposition accumulates. In comparison, as the speed of the weld torch is increased and the feed rate remains consistent, the material deposited will pool less due to elongated deposition of the material as the weld torch moves through the weld path plan. The increased control over deposition layer height provides increased control and stabilization of the finished component height and cross section of each layer pattern. FIG. 10 provides a schematic of a layer pattern with varied speed within a deposition layer. In the example of FIG. 10, the dotted line sections 1001 along the center of the in-fill pattern represent nominal weld torch speed. While keeping the feed stock rate consistent, in one embodiment, or while keeping one or more parameter sets (whether or not these each include a feed stock rate parameter) consistent, in another embodiment, the dashed-and-dotted line sections 1002, dashed line sections 1003, and solid line sections 1004 regions of the layer pattern represent areas of (respectively) increasing weld torch speed as compared to the nominal dotted line sections. In areas of concavity, the layer pattern of one or more deposition layers may incorporate logic to decrease the weld torch speed, such as the dotted line sections 1001, to promote deposition of additional material to counteract the previously printed component's concavity. In areas of convexity, the layer pattern of one or more layers may incorporate logic to increase the weld torch speed, such as the dashed-and-dotted line sections 1002, dashed line sections 1003, and solid line sections 1004 regions, to decrease material deposition to counteract the previously printed component's convexity. In some embodiments, the print of a component may be paused as distortions appear. The subsequent layer patterns may incorporate speed changes in the later deposition layers to counteract and prevent distortions observed during the printing process. Though FIG. 10 depicts sectional speed changes, it should be understood the logic speed changes can be applied using gradient speed changes.

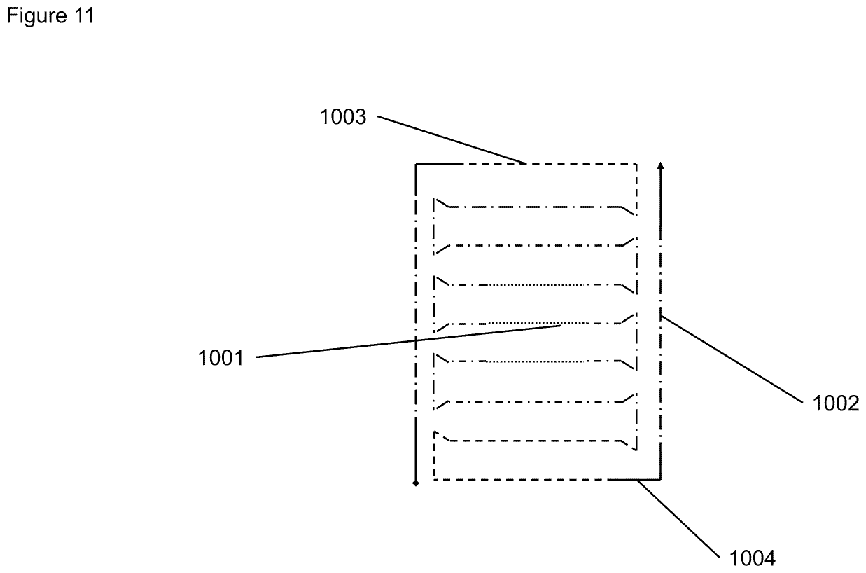

The logic of the speed adjustment within a layer pattern may vary depending on the distance of the weld torch from a reference point. FIG. 10 depicts the logic of the speed adjustment within a layer pattern based on the distance of the weld torch from the perimeter of the component. As described above, the solid line sections 1004 represent an increased weld torch speed as compared to the nominal speed of the dotted line sections 1001 near the center of the component. FIG. 11 depicts the logic of the speed adjustment within many layer patterns within a component based on the distance of the weld torch from the center of the component. The same line type sections of FIG. 10 applies to FIG. 11, such that the dotted line sections 1001 near the center of the component are a nominal speed and the dashed-and-dotted line sections 1002 along the long ends of each component, dashed line sections 1003 along the short ends of each component, and solid line sections 1004 along the two opposing corners of the perimeter pattern representing respectively increased weld torch speed as compared to the nominal speed of the dotted line sections 1001. Though FIG. 11 depicts sectional speed changes, it should be understood that the speed changes can be applied as gradient adjustments.

In many embodiments, the layer pattern may comprise a point map. During the printing process, the logic for the speed of the weld torch may be adjusted at each point in the point map. The representative point map of a layer pattern may have a point density, the number of points within the area of the layer pattern. In some embodiments, the point density of a layer pattern may be consistent. In some embodiments, the point density of a layer pattern may vary across the layer pattern. The logic of the speed adjustments within a layer pattern may maintain a consistent speed at one or more consecutive points. The logic of the speed adjustments within a layer pattern may adjust the weld torch speed at one or more consecutive points. In many embodiments, the logic of the speed adjustments is a gradient, such that the speed of the weld torch is incrementally adjusted at consecutive points. The representative point map of individual layer patterns may vary between layer patterns within a printed component. In some embodiments, the point density between individual layer patterns may be the same within a printed component. In some embodiments, the point density between individual layer patterns may vary based on the geometry of the finished component. In some embodiments, the point density between individual layer patterns may vary based on the increased heat of the previous deposition layers. As more layer patterns are deposited, the component's temperature may increase. To account for the increased wet out of deposited material on the heated component, the logic of speed adjustments may be controlled by the representative point map. In some embodiments, the weld torch speed may be increased through the inclusion of additional points in the point map, such that the speed of the weld torch is incrementally increased at a higher rate than a decreased point density. In some embodiments, the weld torch speed may be increased through increased speed adjustments between consecutive points, such that the degree the speed is adjusted at each point is at a higher rate than a previous layer pattern. Different regions of an individual layer pattern may have various point densities. In some embodiments, the in-fill pattern of a layer pattern may have a higher point density than the perimeter pattern. In various embodiments, the degree of speed adjustment between consecutive points may vary across a layer pattern. In some embodiments, the speed adjustment may vary depending on the region of the point map within the individual layer pattern. The point map in regions of the layer pattern located near the center of the component may incorporate different speed changes than a point map in regions of the layer pattern located near the exterior of the component.

Various parameters, as described herein, including but not limited to layer pattern orientation and/or direction, feed stock rates, shielding gas flow rates, welding voltages and currents, and so on individually or organized as parameter sets, may be adjusted to control total printed component geometry and material properties. The various parameters may be adjusted to remove defects and distortions in subsequently printed components, and to otherwise improve final geometry and material properties, but may still result in concavities and convexities, and other variations in geometry, including variations in final height. The logic of adjusting the speed of the weld torch as described herein, while holding other parameters substantially unchanged, may be incorporated to further remove these lingering defects and distortions in subsequently printed components. The cross section of the individual layer patterns may be further fine-tuned by incorporating the logic of speed adjustments to maintain uniform height of the individual deposition layers.

In some embodiments, the dimensions of the individual layer patterns can vary between deposition layers. The dimensional differences between the varied individual layer patterns may result in a printed component with a complex and/or irregular geometry. Each layer pattern can have a size, defined by the length and width of the sides of the layer pattern. The size of the individual layer patterns may change between layer patterns within a printed component. In some embodiments, the surface area between one or more layer patterns can change across the printed component. In many embodiments, the change in size between layer patterns provides a change in size in at least one direction of the printed component. During printing, the xy-plane can be parallel to the build plate such that the printed component extends along the z-axis. In some embodiments, the size of the layer patterns can change along the x-axis as compared to a previous layer pattern. In various embodiments, the size of the layer patterns can change along the y-axis as compared to a previous layer pattern. In certain embodiments, the size of the layer patterns can change along the x-axis and the y-axis as compared to a previous layer pattern. The size of the layer patterns can simultaneously change along the x-axis and the y-axis such that each side of the layer patterns changes as compared to a previous layer pattern. The individual layer patterns can be configured to change the size in one or more directions across the printed component, such that the size along the x-axis and y-axis changes in different ways. For example, across a printed component, the layer patterns can simultaneously decrease along the x-axis and y-axis as compared to the previous layer pattern to form a pyramid. Across a printed component, the layer patterns can initially decrease along the x-axis as compared to a previous layer pattern. At a certain point along the z-axis, the layer patterns can increase along the x-axis as compared to the previous layer pattern such that a rectangular hourglass is printed. One having ordinary skill in the art would understand a printed component can be designed by adjusting the size of the individual layer patterns across the printed component.

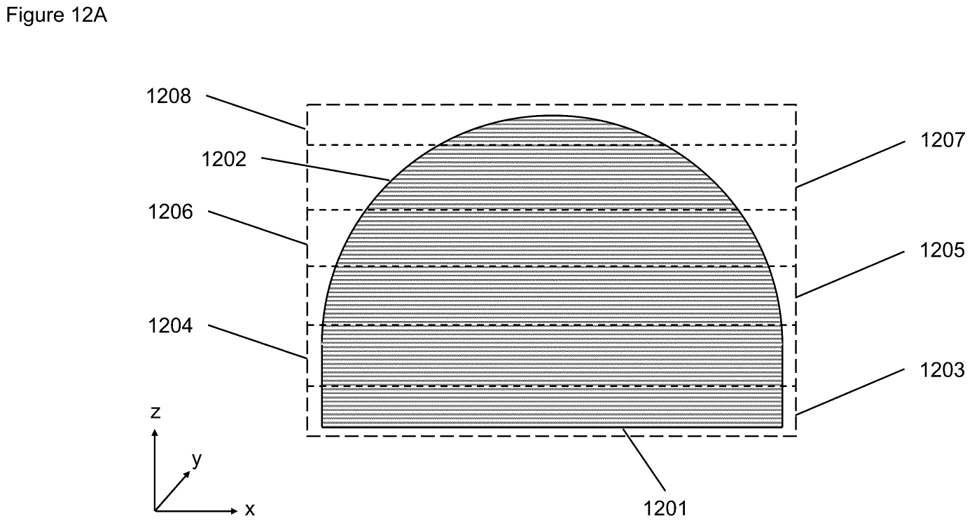

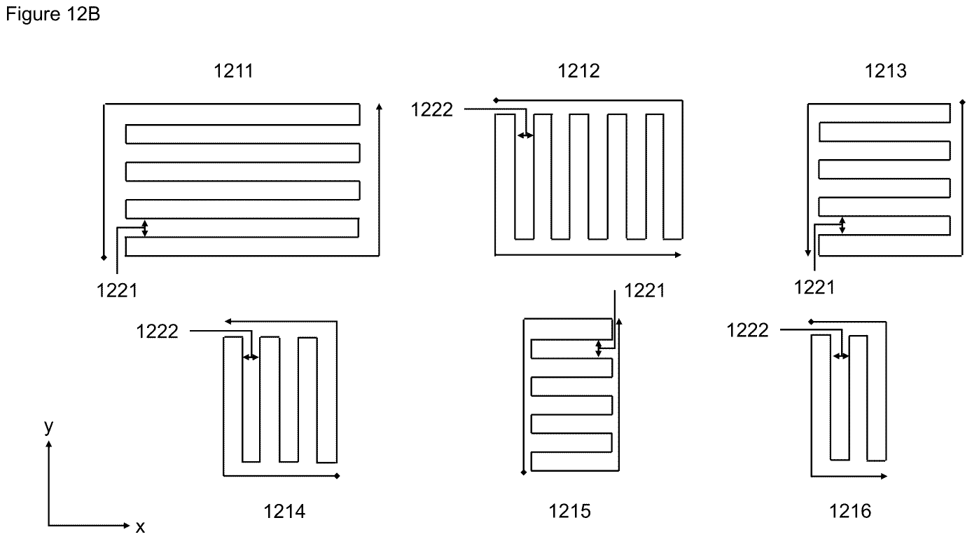

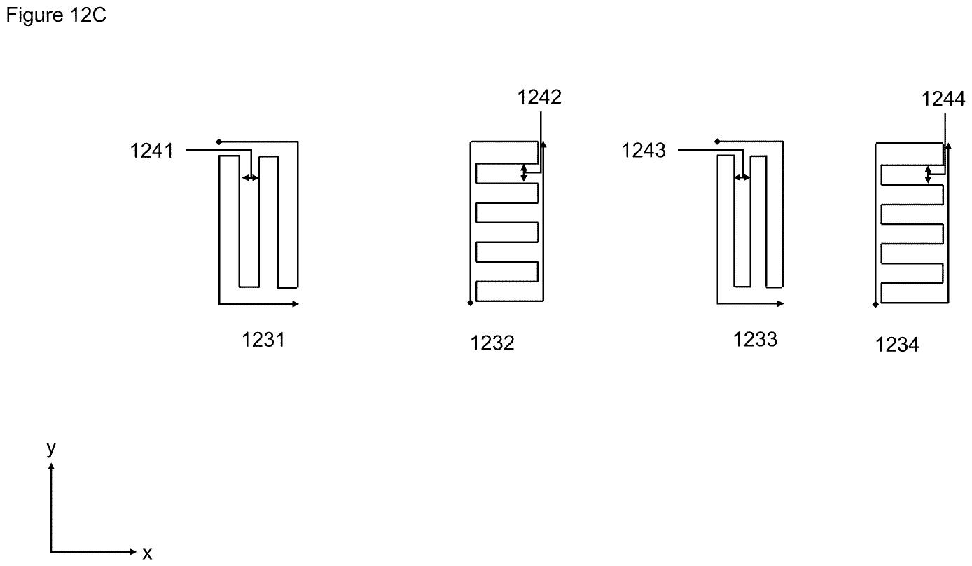

As the sizes of the layer patterns change, the printed component can exhibit curved sides along the direction the layer patterns change. FIG. 12A schematically provides an example of a printed component with a rectangular base (1201) and curved sides (1202). The individual layer patterns within the printed component change in length across the print such that the printed component exhibits curved sides. As shown in FIG. 12A, the printed component curves to form a half-circle because the length of individual layer patterns decreases, along the z-axis. The length of the individual layer pattern can be different in different regions 1203-1208 of the printed component. FIG. 12A provides a non-limiting example of layer patterns having different lengths along the height of the printed component.

Cross sections of the printed component in the xy-plane reduce in area along the z-axis. FIG. 12B provides an example of some of the layer patterns 1211-1216 within the printed component of FIG. 12A. The length of the layer patterns reduces along the x-axis because the individual layer patterns decrease in size. The layer patterns 1211-1216 schematically represent examples of layer patterns within different regions 1203-1208 of the printed component in FIG. 12A. Layer pattern 1211 schematically shows an example of a layer pattern within region 1203 of the printed component. Layer pattern 1212 schematically shows an example of a layer pattern within region 1204 of the printed component. Layer pattern 1213 schematically shows an example of a layer pattern within region 1205 of the printed component. Layer pattern 1214 schematically shows an example of a layer pattern within region 1206 of the printed component. Layer pattern 1215 schematically shows an example of a layer pattern within region 1207 of the printed component. Layer pattern 1216 schematically shows an example of a layer pattern within region 1208 of the printed component. Though layer patterns 1211-1216 are shown to have clocked start points in the sense of FIGS. 5A and 5B, each exemplary layer pattern may not necessarily be adjacent within regions 1203-1208. For example, in one embodiment layer pattern 1211 within region 1203 may be adjacent to layer pattern 1212 within region 1204, while in another embodiment these same layer patterns may be separated by a number of intervening deposition layers consistent with a clocking scheme.

As the layer patterns change sizes, the area within the in-fill pattern changes. As the layer pattern changes size in a direction perpendicular to the in-fill pattern lines, the number of in-fill pattern lines can change. As shown in FIG. 12B, the length of different layer patterns changes along the x-axis while the spacing of the in-fill pattern (1221) remains approximately consistent across layer patterns with parallel in-fill pattern lines. The spacing of the in-fill pattern (1222) remains approximately consistent across layer patterns with in-fill pattern lines perpendicular to the x-axis as the number of in-fill pattern lines changes.

In-fill pattern lines across different layer patterns can have a target spacing. In many embodiments, the layer pattern can define a range of allowable spacing between in-fill pattern lines, such that the in-fill pattern lines can have a distance within an allowable range. For example, the target spacing can be 7.0 mm with an allowable range between 6.9 mm and 7.1 mm. Any allowable range can be applied based on the deposition process and/or desired application. For example, the allowable range can be ±0.1 mm, ±0.3 mm, ±0.5 mm. ±0.7 mm, ±0.9 mm, or ±1.1 mm from the target spacing. In numerous embodiments, as the area of the layer pattern changes, the number of passes within the in-fill pattern can increase or decrease. The number of passes can be determined by dividing the dimensions of the layer pattern by the target spacing. If the dimension of the layer pattern is divisible by the target spacing, the result can determine the number of passes. If the dimension of the layer pattern is not divisible by the target spacing, the target spacing can be adjusted within the allowable range to determine a number of passes. FIG. 12C provides a non-limiting example of consecutive layer patterns 1231, 1232, 1233, and 1234 having varied spacing between the in-fill pattern lines. The layer patterns 1231 and 1233 decrease in length along the x-axis without reducing the number of in-fill pattern lines perpendicular to the x-axis. Instead, the spacing 1243 between the in-fill pattern lines is reduced as compared to spacing 1241, although both are still within the allowable range. In contrast, although the layer patterns 1232 and 1234 also decrease in length along the x-axis, the spacing between in-fill lines 1242 and 1244 can remain equal to each other.

Although a half circle upon a base is provided for in FIGS. 12A to 12C, it should be understood that any geometry can be printed using the disclosed techniques, based on the desired application. In many embodiments, the size of the layer pattern can change in one or more directions or in two or more directions. In various embodiments the area of the layer patterns can decrease across the printed component. In numerous embodiments, the area of the layer patterns can increase across the printed component. In certain embodiments, the area of the layer pattern can increase and decrease across the printed component. For example, the layer patterns can vary size parameters to create an hourglass shaped printed component.

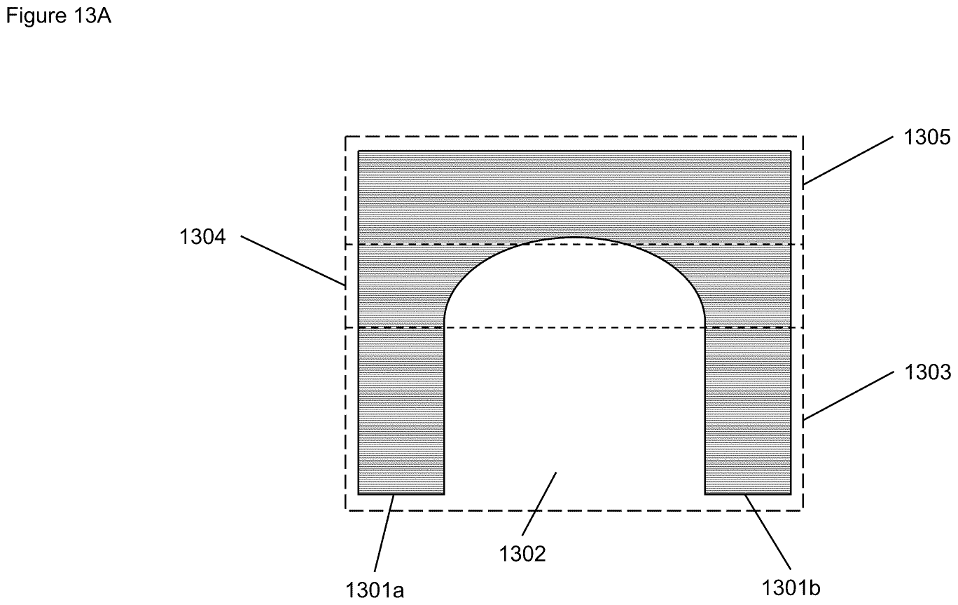

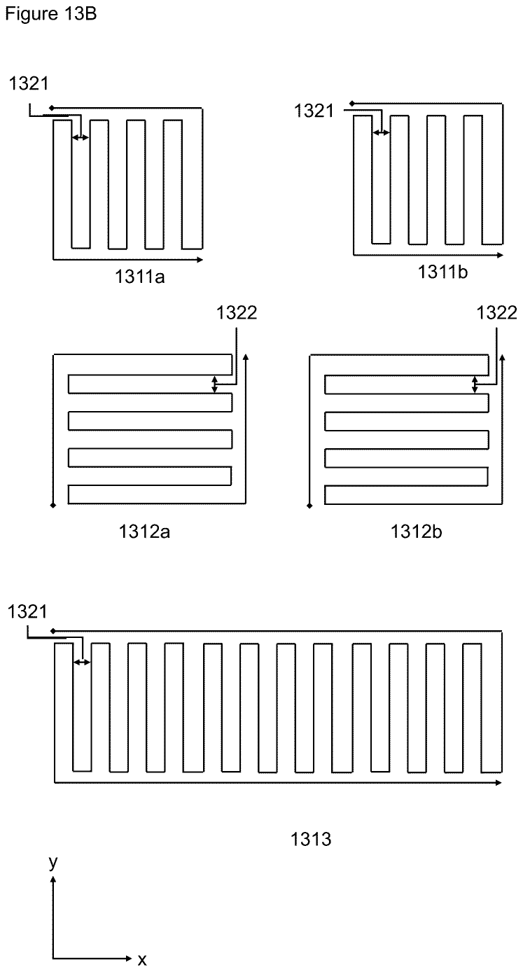

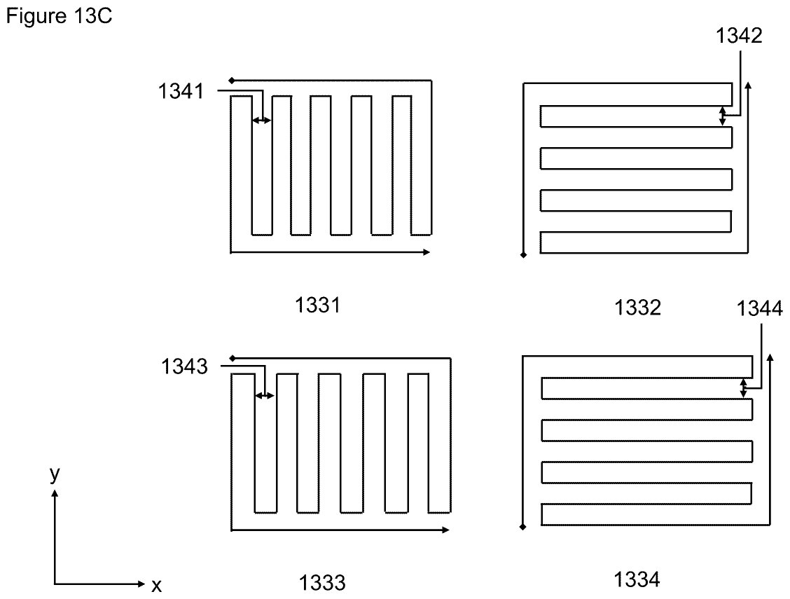

In some embodiments, the dimensions of the layer patterns can be configured to increase to print flared components or even to create negative space within the printed component. The dimensions of the layer patterns can be configured to print components with holes or depressions such that there is space within the printed component without material. For example, the dimensions of the layer patterns can be configured to print an arch, such that the layer patterns allow for negative space between the legs of the arch. FIG. 13A schematically provides an example of a printed arch. The legs 1301a, 1301b of the printed arch can be separated by negative space 1302 by printing separate layer patterns in parallel along the z-axis. The size of the layer patterns within the printed component can change across and/or within different regions 1303-1305. The size of the layer patterns of each leg can change parallel to the xy-plane such that the separate legs come into contact in region 1305. The printed component can transition to print a single layer pattern that spans the distance between the separate legs 1301a, 1301b.

FIG. 13B provide a non-limiting example of various layer patterns at different cross sections of the printed arch depicted in FIG. 13A. Layer patterns 1311a, 1311b schematically illustrate examples of layer patterns within region 1303 forming spatially separated legs of the arch. Layer patterns 1312a, 1312b schematically illustrate spatially separated layer patterns of the arch legs within region 1304. Layer pattern 1313 schematically illustrates a single layer pattern across both legs of the arch within region 1305. The dimensions of the layer patterns can be configured to provide a single layer pattern when the separate arch legs merge, wherein the lengths of the two layer patterns exceed half the total length of the arch along the x-axis. In some embodiments, the layer pattern dimensions can be configured to diverge at a designated z-axis, such that two or more legs are formed after the base has been printed. As the layer pattern increases in size in a direction perpendicular to the in-fill pattern lines, the number of in-fill pattern lines can increases. As shown in FIG. 13B, the length of different layer patterns increases along the x-axis while the spacing of the in-fill pattern 1321, 1320 remains approximately consistent across layer patterns with parallel in-fill pattern lines. For example, the layer patterns 1311a, 1311b at the arch leg bases have 7 in-fill pattern lines, while the layer pattern 1313 near the top of the arch has 23 in-fill pattern lines.

As described above, the spacing between in-fill pattern lines can change within an allowable range as the layer patterns change dimensions in one or more directions. FIG. 13C provides a non-limiting example of consecutive layer patterns 1331, 1332, 1333, and 1334 having varied spacing between the in-fill pattern lines. The layer patterns 1331 and 1333 increase in length along the x-axis without increasing the number of in-fill pattern lines perpendicular to the x-axis. Instead, the spacing 1343 between the in-fill pattern lines is increased as compared to spacing 1341, although both are still within the allowable range. In contrast, although the layer patterns 1332 and 1334 also increase in length along the x-axis, the spacing between in-fill lines 1342 and 1344 can remain equal to each other.

Though FIGS. 12A-12C and 13A-13C schematically illustrate inverse printed components, it should be understood any geometry is contemplated as described herein. A printed component can have varied curvature and/or surface conformity. For example, a printed component can be a pyramid shape, a cone shape, a wave shape, an hour glass shape, a wedge shape, a truss shape, a bridge shape, an x-shape, a v-shape, and/or a hollowed shape.

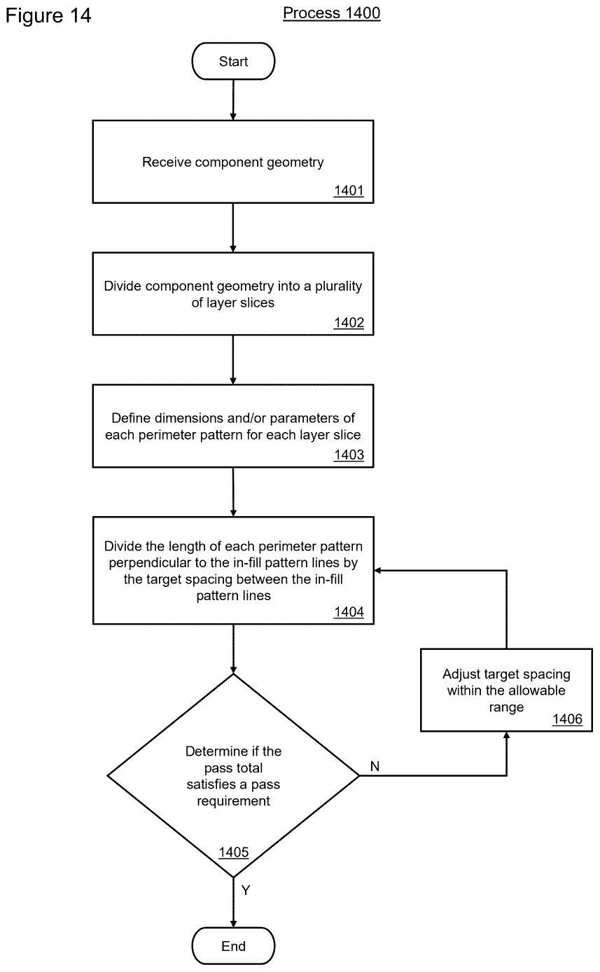

Process 1400 in FIG. 14 determines a plurality of layer patterns to print a component. Process 1400 receives (1401) the desired geometry for the printed component, for example as a CAD file. The desired geometry for the printed component can be curved, contain negative space, and so on. Process 1400 divides (1402) the component geometry into a plurality of layer slices, for example by using a geometry slicer. Process 1400 defines (1403) the dimensions and/or parameters of each layer pattern for each layer slice within the printed component. Each layer pattern can have dimensions and/or parameters as described herein, comprising perimeter pattern dimensions, perimeter pattern shapes, in-fill pattern configuration, and/or start point orientation. In several embodiments, each layer pattern within the printed component has unique dimensions and/or parameters. In some embodiments, one or more layer patterns within the printed component have the same dimensions and/or parameters of another layer pattern within the printed component. In many embodiments, each layer pattern within the plurality of layer patterns incrementally changes in one or more dimensions. For example, the base of the component geometry can have a first length with each successive layer pattern added having a length less than the previous layer pattern. For each layer pattern within the component, process 1400 divides (1404) the length of the perimeter pattern perpendicular to the in-fill pattern lines by the target spacing between the in-fill pattern lines. The target spacing can be the distance between parallel in-fill pattern lines. The result of the division provides a pass total. The pass total can determine the number of passes within the in-fill pattern needed to sufficiently fill the area defined by the perimeter pattern of a specific layer pattern. Process 1400 determines (1405) if the pass total satisfies a pass requirement. The pass requirement can be an allowable rounding amount to reach a whole number of passes for the in-fill pattern. The pass requirement can require a whole number with no rounding The pass requirement can have rounding parameters, such that the rounded number is within the target spacing or allowable range. If the pass total does not satisfy the pass requirement, process 1400 adjusts (1406) the target spacing within an allowable range. As described herein, the allowable range is a parameter surrounding the initial target spacing. The target spacing can be modified to be increased or decreased up to the allowable range. For example, a target spacing can initially be 7 mm with an allowable range of ±0.1 mm, wherein the pass requirement is a whole number without rounding. If a perimeter pattern length is 84 mm, the number result is 12 providing for 12 passes within the in-fill layer pattern. If a perimeter pattern length is 85 mm, the number result is 12.14 which fails the whole number condition. The target spacing can be adjusted within the allowable range of ±0.1 mm to 7.08 mm, such that the number result is 12. The layer pattern with a perimeter pattern length of 85 mm would exhibit an in-fill pattern with 7.08 mm spacing between the in-fill pattern lines. The target spacing can continually be adjusted within the allowable range until the pass total satisfies the pass requirement. Thus, as process 1400 operates across multiple sliced layers to define layer patterns, for curving geometry it will be seen that inter-pass distance increases (for curves making each layer larger) or decreases (for curves making each layer smaller) within a permitted window between pairs of layers subject to the curve (e.g., 1231 and 1233, or 1331 and 1333) separated by an intervening layer not subject to the curve (e.g., 1232 and 1234, or 1332 and 1334), until the number of passes must change accompanied by a respective decrease or increase in inter-pass distance. In many embodiments, a plurality of layer patterns determined by process 1400 can be utilized in process 300 to print a component with the desired geometry.

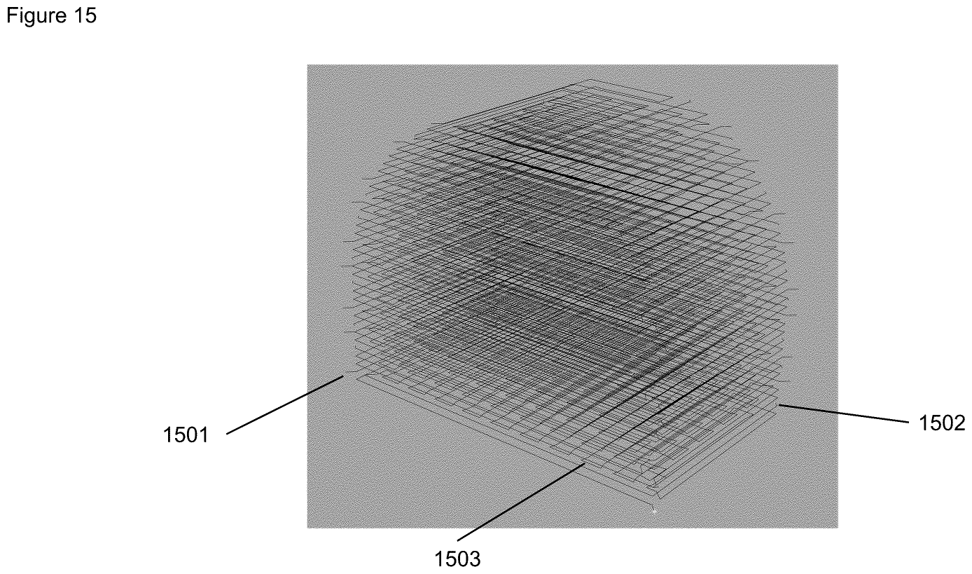

FIG. 15 provides an example of a plurality of layer patterns in accordance with an embodiment. FIG. 15 illustrates a weld path plan for a half-circle component having a rectangular base. The length of the layer pattern changes in one direction as additional layer patterns are stacked. Each layer pattern may comprise a sacrificial start tail 1501 and a sacrificial end tail 1502. Based on the location of each sacrificial start tail 1501 and sacrificial end tail 1502, each layer pattern may have a different start point with respect to the start point of the prior layer pattern. The in-fill pattern of each layer pattern may comprise an extended turn region 1503.

### Doctrine of Equivalents

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

As used herein, the singular terms “a,” “an,” and “the,” may include plural referents unless the context clearly dictates otherwise. Reference to an object in the singular is not intended to mean “one and only one” unless explicitly so stated, but rather “one or more.”

As used herein, the terms “approximately” and “about” are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1 %, less than or equal to ±0.5%, less than or equal to ±0.1 %, or less than or equal to ±0.05%.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. Where ranges are described, the range should be understood to include the endpoints of the ranges, and the endpoints of such ranges are also contemplated to stand on their own as inventive, individual data points and to form the endpoints of other ranges. For example, a ratio in the range of about 1 to about 300 should be understood to include the explicitly recited limits of about 1 and about 300, but also to include individual ratios such as about 2, about 3, and about 4, sub-ranges such as about 1 to about 10, about 10 to about 50, about 20 to about 200, about 200 to about 300, and so forth, and related ranges such as greater than about 1 or less than about 300.

What is claimed is:

1. A method for depositing a layer pattern comprising:
defining a perimeter pattern polygon, wherein the perimeter pattern polygon comprises a first portion and a second portion;
depositing the first portion of the perimeter pattern polygon, wherein depositing the first portion of the perimeter pattern polygon comprises depositing a first tail portion outside the area defined by the perimeter pattern polygon, wherein the first tail portion extends from a start point on the first portion of the perimeter pattern polygon;
depositing an in-fill pattern within an area defined by the perimeter pattern polygon, wherein depositing the in-fill pattern within the area defined by the perimeter pattern polygon ends near the start point; and
depositing the second portion of the perimeter pattern polygon, wherein depositing the second portion of the perimeter pattern polygon comprises depositing a second tail portion outside the area defined by the perimeter pattern polygon, wherein the second tail portion extends from an end point on the second portion of the perimeter pattern polygon.

2. The method of claim 1, further comprising depositing a second layer pattern on top of a first layer pattern, wherein depositing the first portion of the perimeter pattern polygon of the second layer pattern is different than a start point of the first layer pattern.

3. The method of claim 1, wherein depositing the first portion of the perimeter pattern polygon, depositing the in-fill pattern, and depositing the second portion of the perimeter pattern polygon comprises depositing a material at a feed rate; wherein the feed rate is dynamically changed.

4. The method of claim 3, wherein the feed rate of depositing the in-fill pattern is greater than the feed rate of depositing the first portion and the second portion of the perimeter pattern polygon.

5. The method of claim 3, wherein the feed rate of depositing the in-fill pattern is less than the feed rate of depositing the first portion and the second portion of the perimeter pattern polygon.

6. The method of claim 1, wherein the perimeter pattern polygon comprises a first corner and a second corner, wherein the step of deposition the first portion of the perimeter pattern polygon begins at the first corner.

7. The method of claim 6, further comprising depositing a second layer pattern comprising depositing the first portion of the perimeter polygon of the second layer pattern begins at the second corner.

8. The method of claim 6, wherein the in-fill lines are at an offset angle from the in-fill lines of the second layer pattern.

9. The method of claim 8, wherein the first corner and the second corner are adjacent corners within the perimeter pattern polygon, wherein the offset angle is equal to an interior angle of the perimeter pattern polygon.

10. A system for weld path planning comprising:
a controller comprising a processor and a memory, wherein the memory comprises an application configured to direct the processor to perform a method for determining a layer pattern comprising:
determining a perimeter pattern, comprising a first portion and a second portion; and
determining an in-fill pattern within an area defined by the perimeter pattern;
wherein the layer pattern is a portion of a weld path plan that runs continuously from the first portion into the in-fill pattern and from the in-fill pattern into the second portion.

11. The system of claim 10, wherein the first portion of the perimeter pattern further comprises a first tail portion, wherein the first tail portion is outside the area defined by the perimeter pattern, wherein the second portion of the perimeter pattern further comprises a second tail portion, wherein the second tail portion is outside the area defined by the perimeter pattern.

12. The system of claim 10, wherein the in-fill pattern comprises a plurality of in-fill lines and a plurality of turn regions, and wherein the in-fill lines are approximately parallel.

13. The system of claim 12, wherein the first portion of the perimeter pattern comprises a first side and a second side, wherein the second portion of the perimeter pattern comprises a third side and a fourth side, and wherein the second side and the fourth side are approximately parallel to the in-fill lines.

14. The system of claim 12, wherein the in-fill lines are separated by an in-fill space, and wherein the turn region has a radius greater than the in-fill space.

15. The system of claim 10, wherein the in-fill pattern fills the area defined by the perimeter pattern.

16. A system comprising:
a controller comprising a processor and a memory, wherein the memory comprises an application configured to direct the processor to perform a method, the method comprising:
determining a plurality of layer patterns, wherein each layer pattern comprises a continuous deposition, wherein each layer pattern comprises:
a perimeter pattern, comprising a first portion and a second portion; and
an in-fill pattern within an area defined by the perimeter pattern, wherein the in-fill pattern comprises a plurality of in-fill lines and a plurality of turn regions, and wherein the in-fill lines are approximately parallel;
wherein the plurality of layer patterns are stacked, wherein a first layer pattern and a second layer pattern are adjacent in the stack, and wherein the in-fill lines of the first layer pattern are at an offset angle from the in-fill lines of the second layer pattern.

17. The system of claim 16, wherein each layer pattern comprises a start point, wherein the start point is at a corner of the perimeter pattern.

18. The system of claim 17, wherein the start point of the first layer pattern is at a first corner of the perimeter pattern, wherein the start point of the second layer pattern is at a second corner of the perimeter pattern.

19. The system of claim 18, wherein the first corner and the second corner are adjacent corners within the perimeter pattern, wherein the offset angle is equal to an interior angle of the perimeter pattern.

20. The system of claim 16, wherein the first portion of the perimeter pattern of each layer pattern in the plurality of layer patterns comprises a first side and a second side;
wherein the second portion of the perimeter pattern comprises a third side and a fourth side; and
wherein the at least one of the first side, the second side, the third side, or the fourth side of the perimeter pattern of the first layer pattern is different than at least one of the first side, the second side, the third side, or the fourth side of the perimeter pattern of the second layer pattern.
